(19) United States
(12) Patent Application Publication
(10) Pub. No.: US 2023/0411814 A1
(43) Pub. Date: Dec. 21, 2023

(54) APPARATUS AND METHOD FOR BASEBOARD SYSTEM USED IN DRYWALL CONSTRUCTION

(71) Applicant: Jerry MOSCOVITCH, Toronto (CA)

(72) Inventor: Jerry MOSCOVITCH, Toronto (CA)

(21) Appl. No.: 18/242,120

(22) Filed: Sep. 5, 2023

Related U.S. Application Data
(63) Continuation-in-part of application No. 17/188,768, filed on Mar. 1, 2021.
Application No. 17/188,768 is a continuation of application No. 16/224,130, filed on Dec. 18, 2018, now abandoned.

(51) Int. Cl. H01P 1/195; H01P 1/30

(52) U.S. Cl. CPC H01P 1/195; H01P 1/30

(57) ABSTRACT

Described herein is a method for creating a reveal in a wall with the use of a drywall board and baseboard. A backing is secured to the back side of the drywall board or the baseboard, which is then affixed to studs on the wall. The other of the drywall board and the baseboard is also affixed to the studs so that there is an overlap with the backing. A reveal is thereby created that exposes the backing.

### CROSS-REFERENCE TO RELATED APPLICATION(S)

This application is a continuation-in-part of U.S. application Ser. No. 17/188,768 filed Mar. 1, 2021, which is a continuation of Ser. No. 16/224,130 filed Dec. 18, 2018, which claims priority from provisional application 62/607,517 filed Dec. 19, 2017, all of which are incorporated herein by reference.

### FIELD OF THE INVENTION

The present invention is directed to a drywall apparatus and method, and more particularly to a system for creating a reveal between a baseboard and a drywall board, and method for doing same.

### BACKGROUND OF THE INVENTION

One aesthetically pleasing way to construct a wall using gypsum or drywall board involves leaving a gap of approximately 1 cm between a baseboard and a drywall board above it. This gap is referred to as a “reveal.” A typical method for creating a drywall reveal is to use a “Z-shaped” moulding that is glued and/or stapled on the front side of the drywall at the bottom thereof. In position, the moulding gives a clean line along the bottom front edge of the board. The moulding is also designed to cover the back of the recessed space or gap between the drywall board and the baseboard to hide the studs or insulation behind the board.

The moulding is fastened to a standard drywall board at the job site. Drywall compound is then added to the moulding and drywall board, and then feathered out. After drying, the compound is sanded. This process of applying compound, feathering and sanding may be repeated several times with the aim of achieving a transition from the raised surface of the moulding to the surface of the drywall that is seamless and cannot be seen when the wall is painted. This process is relatively time consuming and costly.

### SUMMARY OF THE INVENTION

It is an aspect of the present invention to provide a drywall board system for use in conjunction with a baseboard is described. The drywall board system includes a drywall board for securing to framing members. The drywall board has a back side designed to be adjacent to the framing members when the drywall board is secured thereto, and a front side opposite the back side. Framing drywall liner lines the back side while finishing drywall liner lines the front side. Gypsum material is sandwiched between the framing and finishing drywall liners. The drywall board system further includes a board backing for receiving at least a portion of the baseboard. The board backing is fastened to the back side of the drywall board, such that the board backing extends downward from a bottom of the drywall board.

The board backing may be fastened to the back side of the drywall board with at least one of screws screwed into the back side, nails driven into the back side and adhesive applied to either the gypsum material at the back side or the framing drywall liner.

Also described herein is a baseboard system for use in conjunction with a drywall board. The baseboard system includes a baseboard for securing to framing members. The baseboard has a back side designed to be adjacent to the framing members when the baseboard is secured thereto, and a front side opposite the back side. The baseboard system also includes a board backing for receiving a portion of a drywall board. The board backing is fastened to the back side of the baseboard and extends upwards from the top of the baseboard.

In an aspect, there is provided a drywall board system for forming a reveal, comprising a drywall board for securing to framing members, the drywall board having a) a back side designed to be adjacent to the framing members when the drywall board is secured thereto, and b) a front side opposite the back side; the system including a framing drywall liner on the back side; a finishing drywall liner on the front side; gypsum material sandwiched between the framing and finishing drywall liners; a baseboard having a horizontal groove therein; and a combination reveal and baseboard locator attached to the drywall board, wherein the combination reveal and baseboard locator includes a reveal portion and a rib that projects horizontally from the reveal portion and is dimensioned to fit into the groove in the baseboard and thereby align the reveal portion and the baseboard.

In other aspects, the reveal portion of the combination reveal and baseboard locator is straight and attaches to the framing drywall liner on the back side of the drywall board, or the reveal portion is angled and includes an attachment portion for attachment to the finishing drywall liner on the front side of the drywall board.

In another aspect a method for installing drywall is provided to create a reveal in a wall that extends from a floor, the method comprising providing a drywall board; providing a baseboard extending upward from the floor, wherein the baseboard includes a horizontal groove; providing a combination reveal and baseboard locator to the drywall board, wherein the combination reveal and baseboard locator includes a reveal portion and a rib that projects horizontally from the reveal portion; attaching the reveal portion to the drywall board; and inserting the rib into the horizontal groove so as to align the reveal portion and the baseboard.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIGS. 1A and 1B show a front and cross sectional view, respectively, of a drywall board system, according to the principles of the present invention.

FIGS. 2A-C show one variation of the drywall board system of FIGS. 1A and 1B in which magnets are employed, according to the principles of the present invention.

FIGS. 3A and 3B show one variation of the drywall board system of FIGS. 1A and 1B in which a horizontal groove is formed and shown, respectively, in an unfolded position and a folded position, according to the principles of the present invention.

FIGS. 4A and 4B show a drywall board system with a different horizontal groove than that of FIGS. 3A and 3B, according to the principles of the present invention.

FIGS. 5A and 5B show a baseboard system for use in conjunction with a drywall board, according to the principles of the present invention.

FIGS. 6A-6C show a variation of the baseboard system of FIGS. 5A and 5B in which a flange runs longitudinally and along a board backing, according to the principles of the present invention.

FIG. 7 shows a flow chart for constructing a reveal using the baseboard system of FIGS. 6A-6C.

FIG. 8A shows a front perspective view of an additional variation of the baseboard system of FIGS. 5A and 5B in which a combination reveal and baseboard locator may be attached to a drywall board backing and a baseboard, according to the principles of the present invention.

FIG. 8B shows a rear perspective view of the baseboard system of FIG. 8A.

FIG. 8C shows a left side view of the baseboard system of FIG. 8A.

FIG. 8D shows a front view of the baseboard system of FIG. 8A.

FIG. 8E shows a right side view of the baseboard system of FIG. 8A.

FIG. 8F shows a rear view of the baseboard system of FIG. 8A.

FIG. 8G shows a top view of the baseboard system of FIG. 8A.

FIG. 8H shows a bottom view of the baseboard system of FIG. 8A.

FIG. 9A shows a front perspective view of the combination reveal and baseboard locator of FIG. 8A.

FIG. 9B shows a rear perspective view of the combination reveal and baseboard locator of FIG. 9A.

FIG. 9C shows a left side view of the combination reveal and baseboard locator of FIG. 9A.

FIG. 9D shows a front view of the combination reveal and baseboard locator of FIG. 9A.

FIG. 9E shows a right side view of the combination reveal and baseboard locator of FIG. 9A.

FIG. 9F shows a rear view of the combination reveal and baseboard locator of FIG. 9A.

FIG. 9G shows a top view of the combination reveal and baseboard locator of FIG. 9A.

FIG. 9H shows a bottom view of the combination reveal and baseboard locator of FIG. 9A.

FIG. 10A shows a front perspective view of an alternative embodiment of the combination reveal and baseboard locator of FIG. 9A.

FIG. 10B shows a rear perspective view of the combination reveal and baseboard locator of FIG. 10A.

FIG. 10C shows a left side view of the combination reveal and baseboard locator of FIG. 10A.

FIG. 10D shows a front view of the combination reveal and baseboard locator of FIG. 10A.

FIG. 10E shows a right side view of the combination reveal and baseboard locator of FIG. 10A.

FIG. 10F shows a rear view of the combination reveal and baseboard locator of FIG. 10A.

FIG. 10G shows a top view of the combination reveal and baseboard locator of FIG. 10A.

FIG. 10H shows a bottom view of the combination reveal and baseboard locator of FIG. 10A.

FIG. 10I shows a left side view of a baseboard system using the combination reveal and baseboard locator of FIG. 10A.

FIG. 10J shows a front view of the baseboard system of FIG. 10C.

FIG. 10K shows a right side view of the baseboard system of FIG. 10C.

FIG. 10L shows a rear view of the baseboard system of FIG. 10C.

FIG. 10M shows a front perspective view of the baseboard system of FIG. 10C.

FIG. 10N shows a rear perspective view of the baseboard system of FIG. 10C.

FIG. 11A is a top perspective view and FIG. 11B is a left and front perspective view of a baseboard for use with the combination reveal and baseboard locator of FIGS. 9A and 10A.

FIG. 12 is a flowchart showing a method for installing the baseboard system of FIG. 8A and FIG. 10M.

### DETAILED DESCRIPTION OF THE PREFERRED EMBODIMENTS

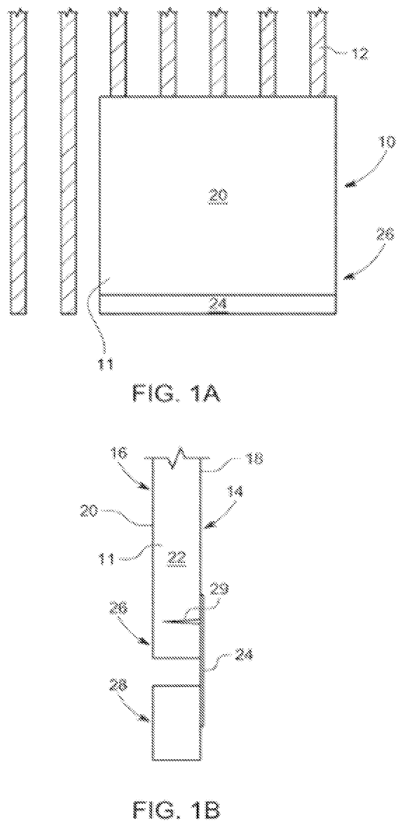

FIGS. 1A and 1B show a front and cross sectional view, respectively, of a drywall board system 10 having a drywall board 11 for securing to framing members 12. As explained in more detail below, FIG. 1A does not include a baseboard 28, whereas FIG. 1B includes a baseboard 28. Framing members 12 can include wood or metal studs to which the drywall board 11 may be screwed or nailed. The drywall board 11 has a back side 14 and a front side 16 opposite the back side 14. The back side 14 is the side of the drywall board 11 that is adjacent to the framing members 12 when the drywall board 11 is screwed or nailed thereto. The front side 16, on the other hand, is the opposite side of the drywall board 11 that, after installation, is usually painted, plastered, wall papered or otherwise finished. The back side 14 has framing drywall liner 18, such as drywall paper. The front side 16 has finishing drywall liner 20, such as drywall paper. The framing drywall liner 18 and the finishing drywall liner 20 may be the same, or may have different characteristics, such as different thicknesses. Gypsum material 22 is sandwiched between the framing drywall liner 18 and the finishing drywall liner 20.

In addition to the drywall board 11, the drywall board system 10 further includes a board backing 24 that is fastened to the back side 14 of the drywall board 11. The board backing 24 extends downward from a bottom 26 of the drywall board 11, in one embodiment without contacting the front side 16 of the drywall board 11. The term “bottom” refers to a portion of the board 11 that, when the drywall board system 10 is installed, would be nearest the floor. The board backing 24 receives a portion of a baseboard 28 to form a reveal. The term “receive” can include embodiments in which the baseboard 28 abuts or overlaps the board backing 24. In one embodiment, the board backing 24 extends downward from the bottom 26 of the drywall board 11 by about two inches.

The board backing 24 may be attached to the back side 14 of the drywall board 11 with fasteners, such as screws 29 that are screwed through the framing drywall liner 18 and into the gypsum material 22 without piercing the finishing drywall liner 20. Alternatively, the board backing 24 may be fastened to the back side 14 of the drywall board 11 by bonding with adhesive, for example.

In one embodiment, the board backing 24 contains metal that is attracted to magnetic material in the baseboard 28, or the opposite arrangement where the baseboard 28 contains metal and the board backing 24 contains magnetic material is also possible. The attraction of the metal to the magnetic material helps affix the baseboard 28 to the board backing 24. The metal can be white, pre-coated steel or aluminum, for example. In one embodiment, the thickness of the board backing 24 is about 0.032 inches.

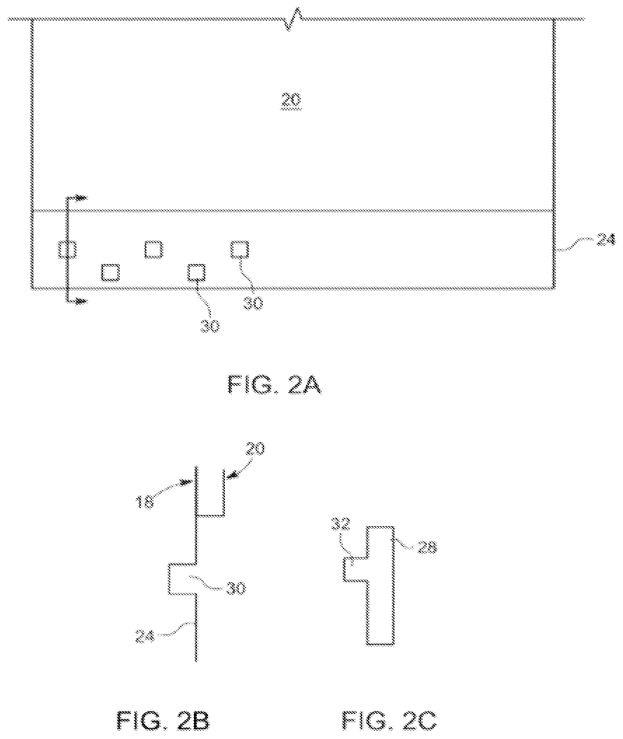

FIGS. 2A-2C show an embodiment consistent with the present invention that employs a magnet. Pockets 30 are stamped into a metallic board backing 24. Complimentary magnetic projections 32 are disposed on the surface of the baseboard 28 projecting from the rear of the baseboard 28 (see FIG. 2C). The magnetic projections 32 fit into the pockets 30 and are affixed thereto, in whole or in part, via the attraction between magnetic material in the magnetic projections 32 and the metallic baseboard backing 24. The attraction of the metal to the magnetic material helps affix the baseboard 28 to the board backing 24 in an appropriate position. The appropriate position would leave the board backing 24 levelled and at the right height to leave a suitable gap for the reveal. The gap, for example, can be in the range of 1-3 cm. It is also contemplated that instead of having the pockets 30 in the board backing 24 and the projections 32 in the baseboard 28, the pockets can reside in the baseboard and the projections in the board backing.

It is aesthetically desirable for the front bottom edge of the drywall board 11 to have a sharp edge. At least two ways to form this edge are now described.

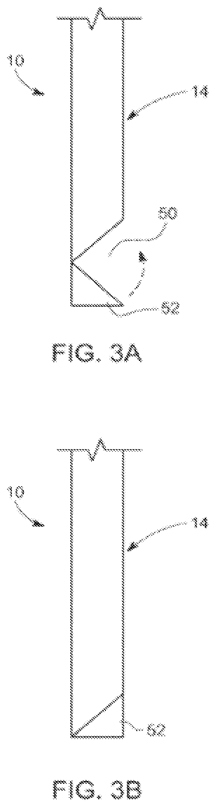

With reference to FIGS. 3A and 3B, a horizontal groove 50 is formed on the back side 14 of the drywall board 11. A hingeable lower lip 52 is thus created at the bottom of the drywall board 11. In FIG. 3B, the lip 52 is shown in a folded position attained by rotating the lip 52 to close the groove 50, which action is suggested by the dashed arrow in FIG. 3A. Adhesive, for example, can be used to keep the lip 52 in the folded position shown in FIG. 3B.

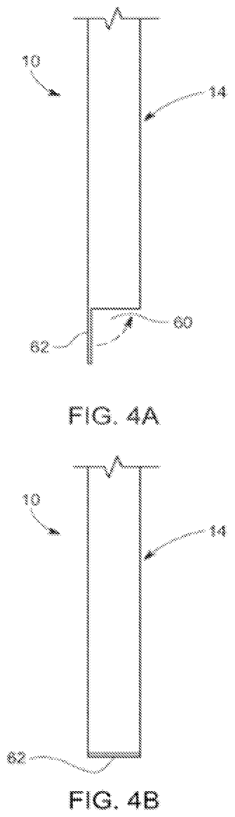

FIGS. 4A and 4B show a different horizontal groove 60 formed on the back side 14 of the drywall board 11. A hingeable lower lip 62 is thus created at the bottom of the drywall board 11. In FIG. 4B, the lip 62 is shown in a folded position attained by rotating the lip 62 to close the groove, which action is suggested by the dashed arrow in FIG. 4A. As in the previous embodiment, adhesive can be used to keep the lip 62 in the folded position shown in FIG. 4B.

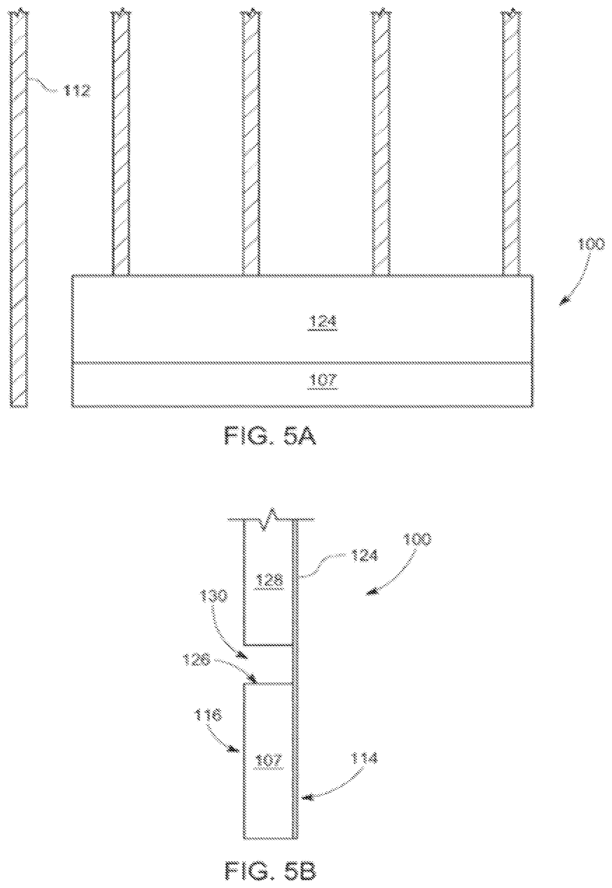

Instead of disposing a backing on the drywall board, the backing can instead be disposed on the baseboard. Such an alternative is described in FIG. 5A (front view) and 5B (cross-sectional view), where a baseboard system 100 that accepts a drywall board 128 is shown. As explained in more detail below, FIG. 5A does not include a drywall board, whereas FIG. 5B includes a drywall board 128. The drywall board 128 is secured to framing members 112. Framing members 112 can include wood or metal studs to which the baseboard system 100 may also be screwed or nailed. The baseboard system 100 includes a baseboard 107 having a back side 114 and a front side 116 opposite the back side 114. The back side 114 is the side of the baseboard 107 that is adjacent to the framing members 112 when the baseboard system 100 is affixed thereto, such as with screws or nails. The front side 116, on the other hand, is the opposite side of the baseboard 107 that, after installation, may be left as is, painted or otherwise finished. The baseboard 107 is comprised of an appropriate material, such as wood, gypsum material, elastomer, plastic, metal, stone, medium density fiberboard (MDF), or polyurethane.

In addition to the baseboard 107, the baseboard system 100 further includes a board backing 124. The board backing 124 extends upward from a top 126 of the baseboard 107, in one embodiment without contacting the front side 116 of the baseboard 10. The term “top” refers to a portion of the baseboard 107, which, when the baseboard system 100 is installed, would usually be the portion furthest from the floor. The board backing 124 receives a portion of a drywall board 128 to form a reveal or gap 130 between the baseboard 107 and the drywall board 128. The term “receives” can include embodiments in which the drywall board 128 abuts or overlaps the board backing 124. In the former case, when the drywall board 128 is meant to merely abut the board backing 124, the height of the portion of the board backing 124 that extends above the top 126 of the baseboard 107 would be the height of the reveal.

In some embodiments, the board backing 124 can be rigid or semi-rigid to allow some flex, and can be composed of wood, elastomer, plastic, polyurethane or metal.

In one embodiment, the baseboard 107 and the board backing 124 are two separate pieces that are fastened together, such as with nails, screws or adhesive. In another embodiment, the baseboard and board backing may be formed as one piece. For example, such a baseboard system may be manufactured by injection moulding or die casting using a single mould. For this purpose, the baseboard system may be made out of metal, elastomer or thermoplastic.

The height of the portion of the backing 124 that extends upwards past the top of the baseboard 107 can range from the height of the intended reveal to many centimetres beyond. In one embodiment, the height of this portion of the backing can be one centimetre or less. This would be useful in a process where the drywall board 128 is affixed to the studs 112 before the baseboard system. In such case, the relatively short height of the portion of the backing 124 can be squeezed between the drywall board 128 and the studs 112.

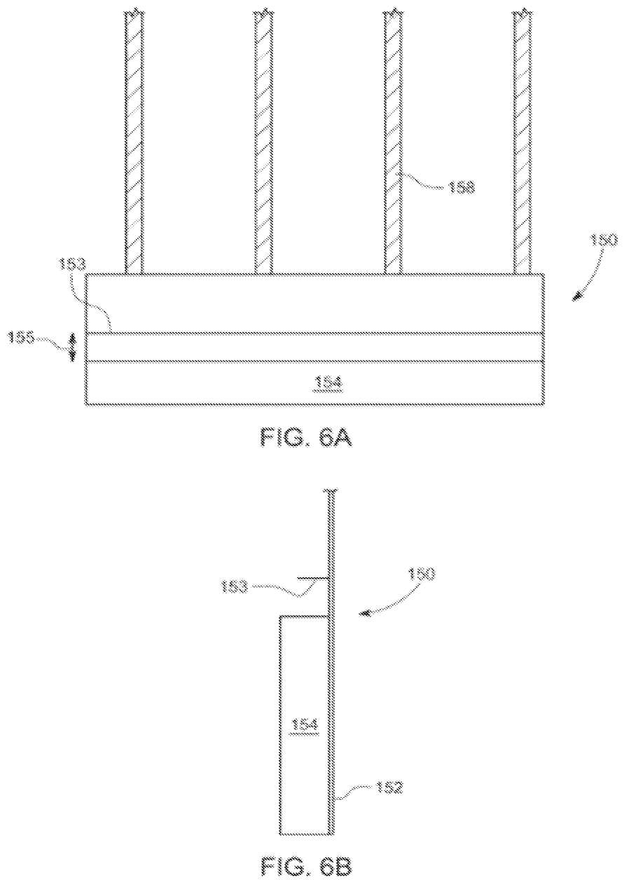

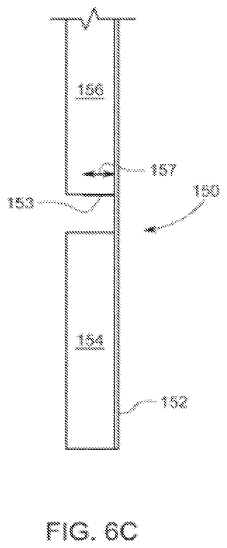

FIGS. 6A-6C show another embodiment of a baseboard system having a flange. The baseboard system 150, which includes a baseboard 154, of FIG. 6A— 6C is similar to the baseboard system 100, but in addition has a board backing 152 that includes a flange 153 that runs longitudinally. The vertical distance 155 from the top of the baseboard 154 to the flange 153 corresponds to the height of the reveal or gap that is created. Advantageously, as shown in FIG. 6C, a drywall board 156 can rest on the flange 153 while the board is being secured to the studs 158. The depth 157 of the flange 153, which in FIGS. 6B and 6C is the distance of the flange as measured from left to right is no larger than the thickness of the drywall board, e.g., half the thickness. In a preferred embodiment, the flange 153 has a depth that is large enough to allow the drywall board 156 to rest thereon, but small enough that it is not easily seen after the baseboard system 150 and drywall board 156 are installed. In one embodiment, a range for the depth of the flange of 25% to 75% of the thickness of the drywall board is appropriate. If the thickness of the board is ½ of an inch, this corresponds to a range for the depth of the flange of 0.125-0.375 inches; if the thickness is % of an inch, this corresponds to a depth of 0.0938-0.281 inches. In another embodiment, the depth of the flange is equal to the thickness of the drywall board.

It will be appreciated that while the flange 153 in the embodiment of FIGS. 6A-6C is disposed approximately midway up the backing 152, in another embodiment the flange can be disposed at or near the top of the backing 152, including the very top. In the latter case, where the flange 153 is disposed at the very top of the backing, no amount of backing extends above the flange. Such a configuration might be employed when the drywall board 156 is affixed to the studs 158 first, before the baseboard system 150 is affixed to the studs.

In addition to providing a resting surface for the drywall board 156 that makes installation easier, the flange 153 furnishes the correct height and levelling of the reveal without having to make measurements.

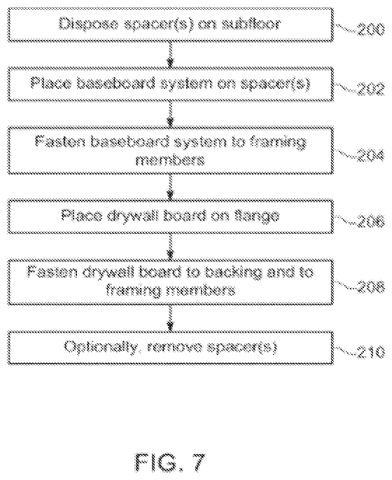

FIG. 7 shows a flow chart for constructing a reveal using the baseboard system of FIGS. 6A-6C. In step 200, at least one flooring spacer is disposed on a subfloor. The flooring spacer can be a block of wood or any other appropriate material that has the same height as the flooring that will be installed on the subfloor. Alternatively, the flooring spacer can be an element of the flooring that will be installed on the subflooring, such as a hardwood, cork, bamboo floorboard, or tile. In step 202, the baseboard system is placed on the at least one flooring spacer. In step 204, the baseboard system is fastened to framing members, such as wood studs, with screws or nails. In step 206, a drywall board is placed on the flange to rest thereon. In step 208, the drywall board is fastened to the board backing and to the studs. In optional step 210, the at least one flooring spacer can be removed. The flooring spacer would typically be removed if the flooring spacer is a block of wood used merely for spacing. On the other hand, if the flooring spacer is a floorboard, the flooring spacer can be left in place if the floorboard is one of many other floorboards comprising the flooring, and more floorboards are to be added on the subflooring to complete the flooring. In the latter case, the floorboard can optionally be removed until the drywall is installed, at which point the flooring can be installed. Such might be the case if the drywall boards or baseboard is to be painted; by removing the floorboards, one avoids getting paint splatter on the floorboards. In any of these alternatives, a suitable spacing is achieved between the bottom of the baseboard and the subflooring to ensure proper fitting of the flooring members therebetween.

In this vain, some or all of the baseboard can be covered or shrink wrapped with a protective plastic, or other suitable material, to avoid getting paint splatter on the baseboard if the drywall above the baseboard is to be painted. After the paint dries, the cover or shrink wrap on the baseboard is designed to be easily removed.

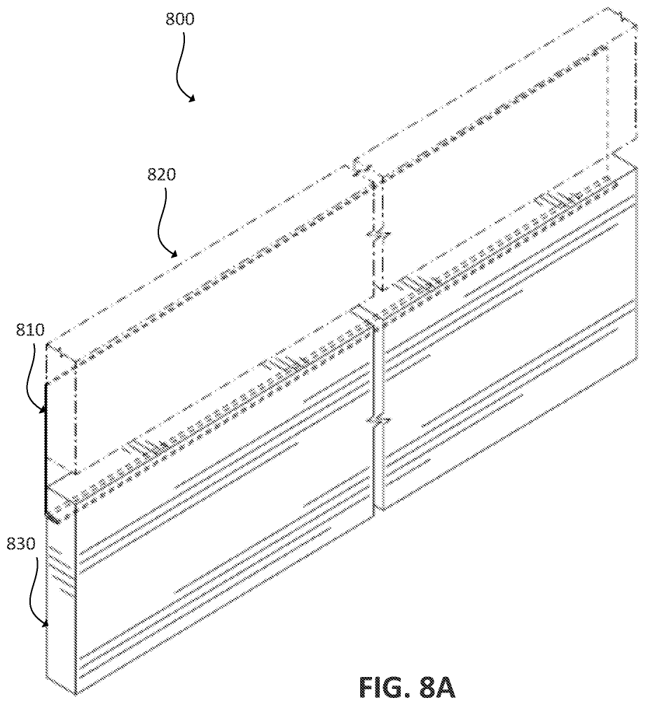

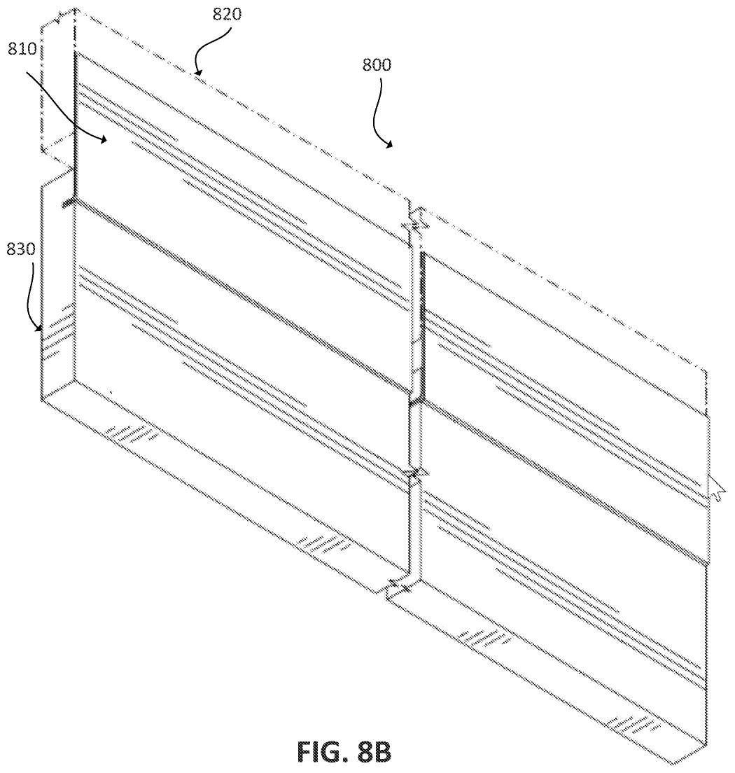

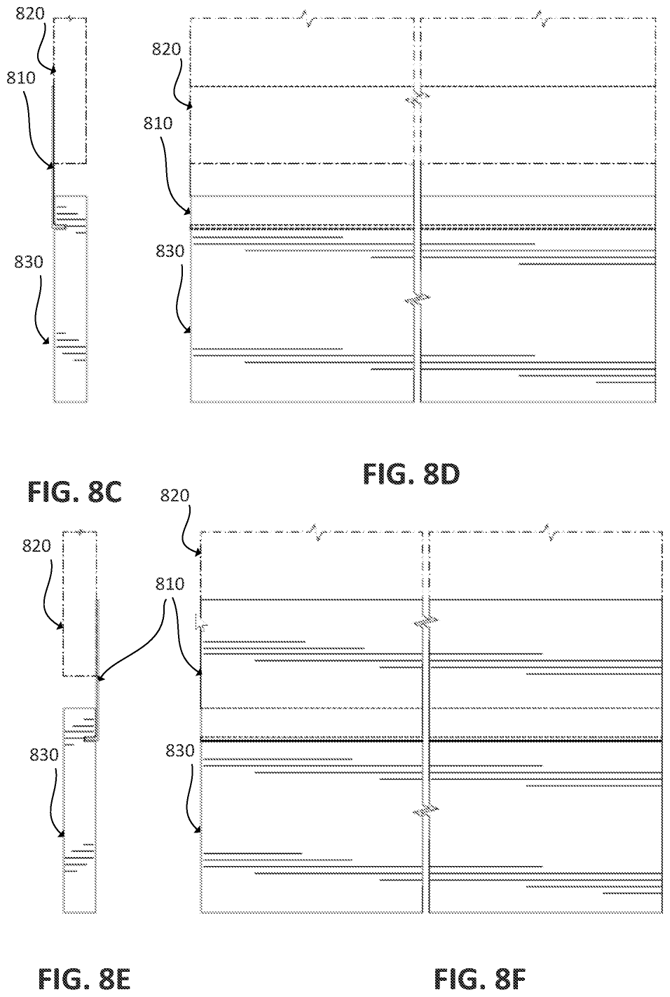

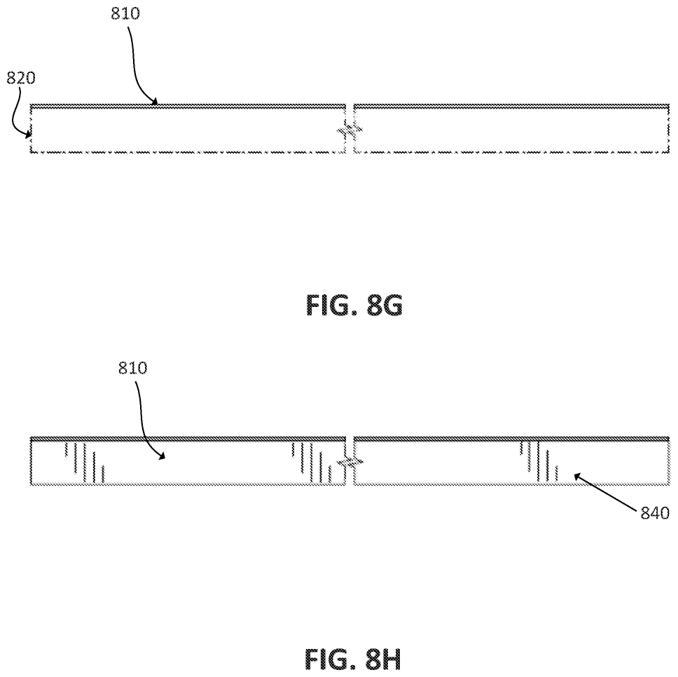

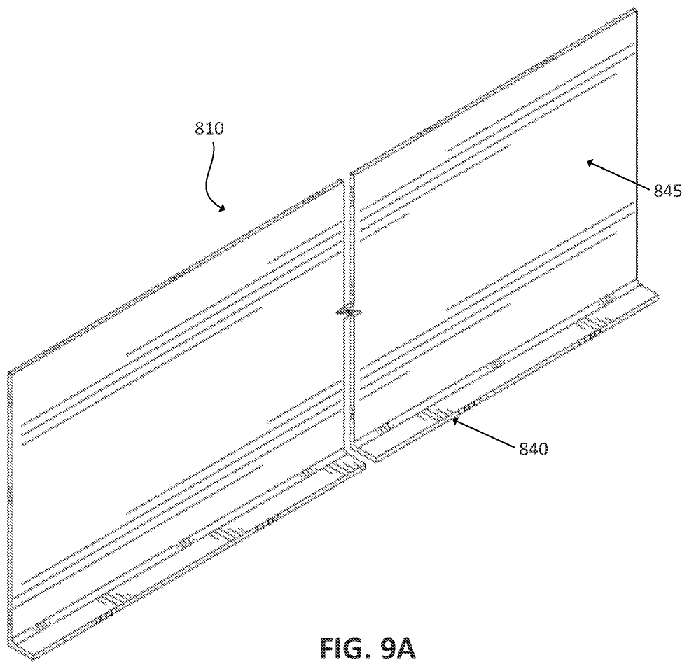

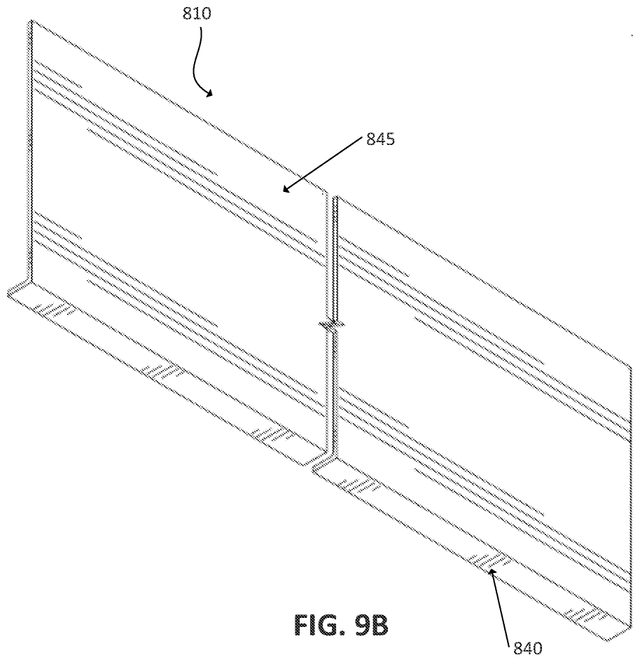

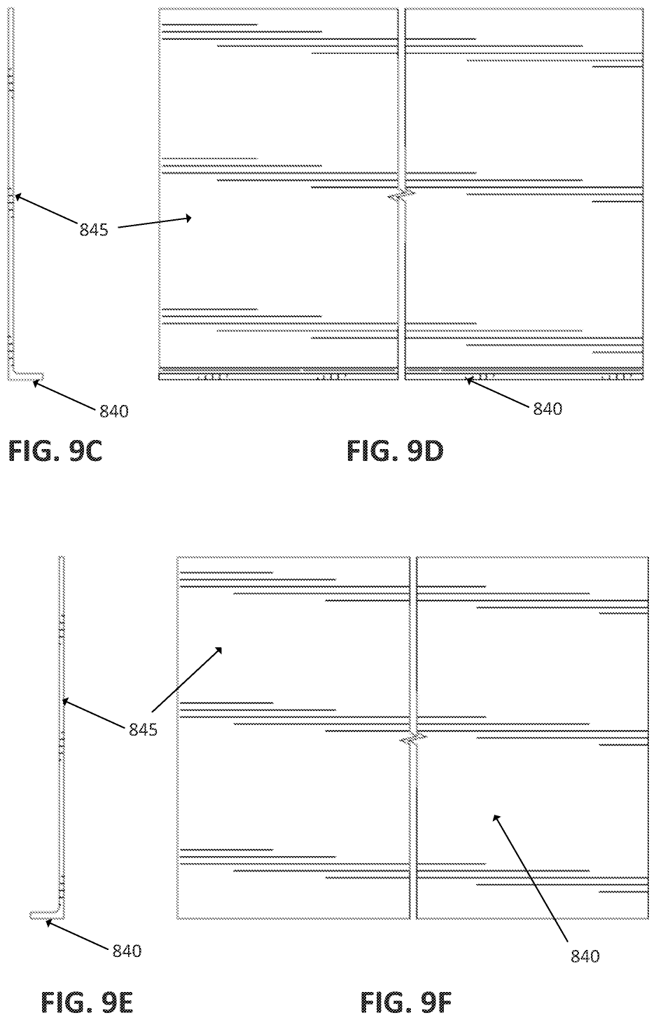

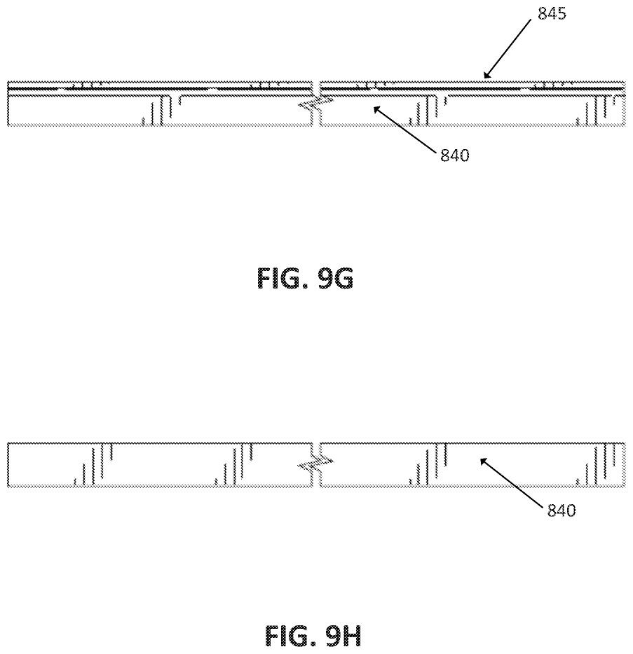

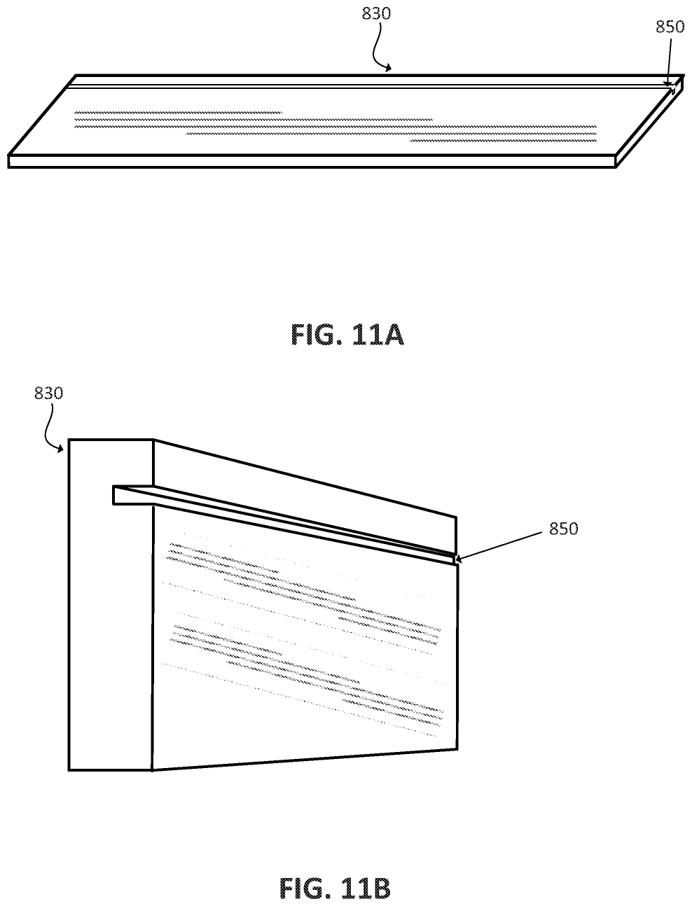

FIGS. 8A-8H show an additional variation 800 of the baseboard system of FIGS. 5A and 5B in which a combination reveal and baseboard locator 810 may be attached to the backing of a drywall board 820 (shown in outline and forming part of the wall) and a baseboard 830 using, for example, double sided tape of adhesive. The combination reveal and baseboard locator 810 includes a 90 degree rib 840 that projects horizontally from the bottom of a reveal portion 845 and functions as a baseboard locator that is dimensioned to fit into a corresponding groove 850 in the baseboard 830, shown in FIGS. 11A and 11B. Combination reveal and base locator 810 can be made of metal or other suitable material. The reveal portion 845 can be of various dimensions to accommodate different sizes (i.e. height) of baseboard 830. Similarly, groove 850 can be located at any suitable location along the height of baseboard 830. FIGS. 9A-9H show the combination reveal and base locator 810 in isolation, comprising reveal portion 845 and 90 degree rib 840 projecting horizontally therefrom.

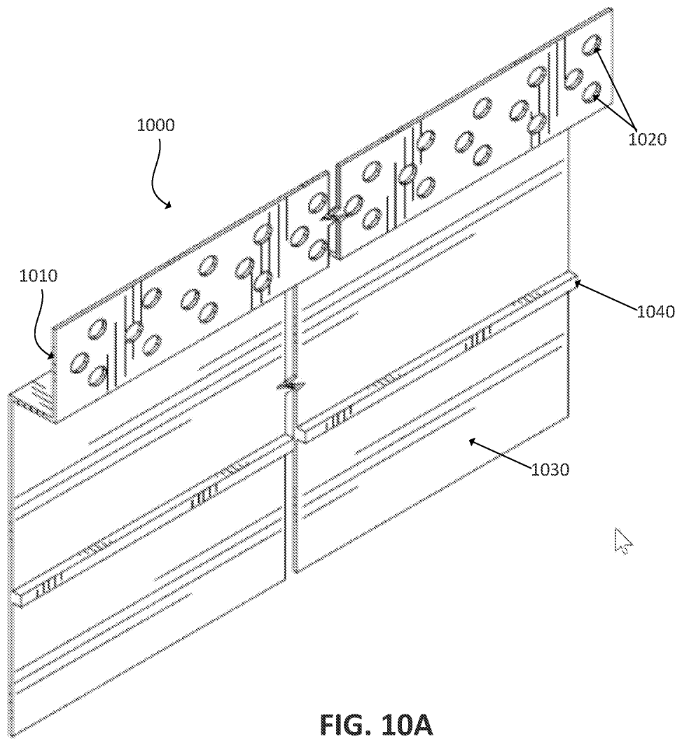

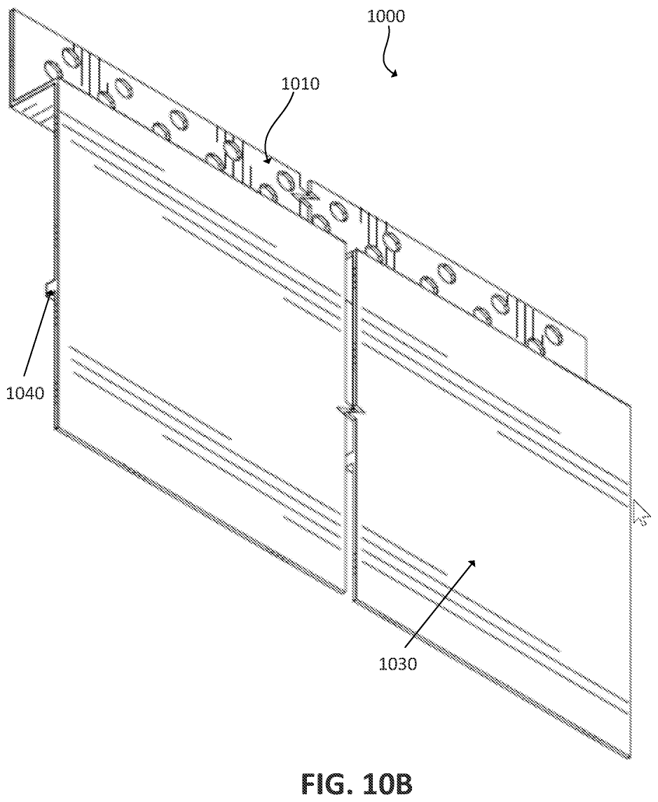

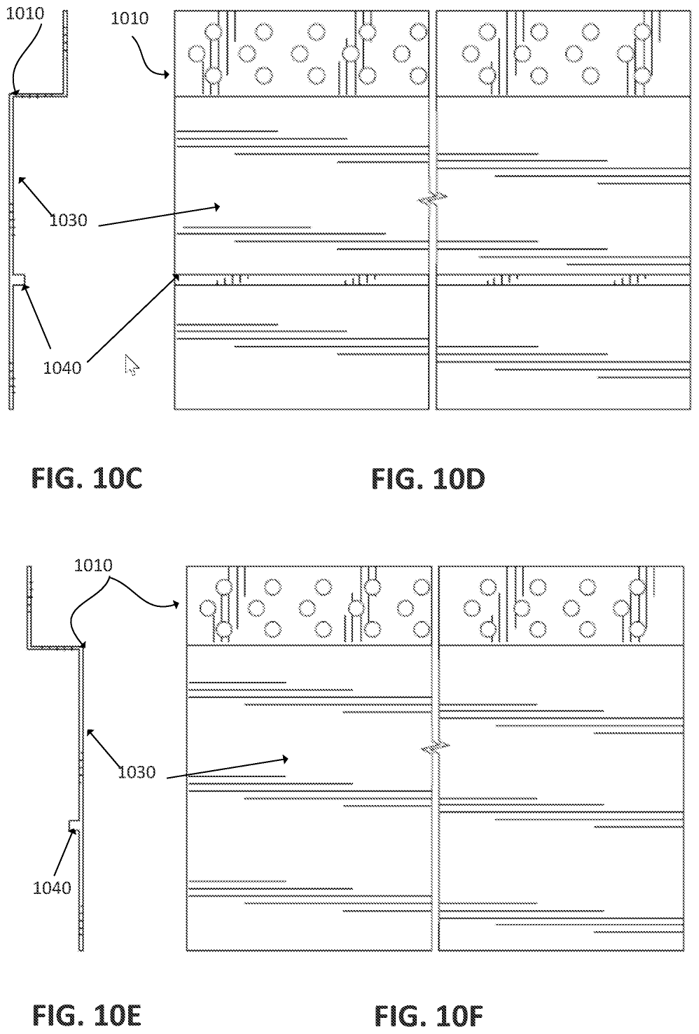

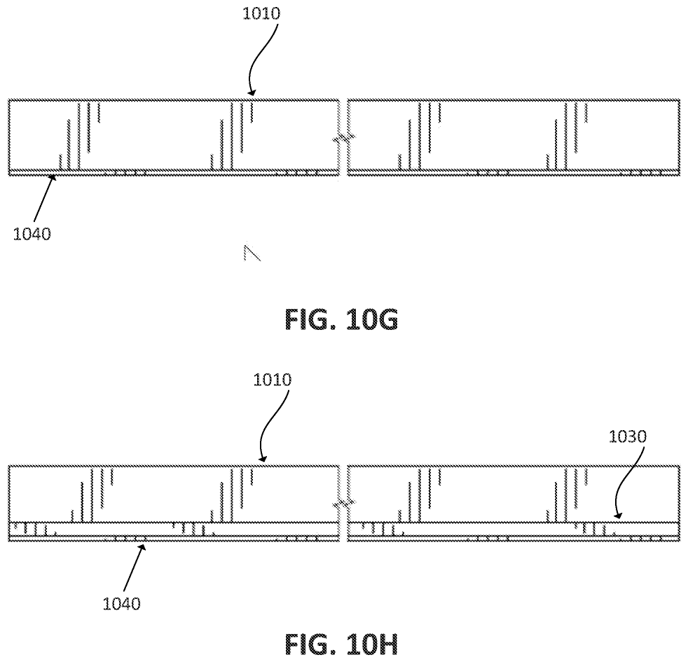

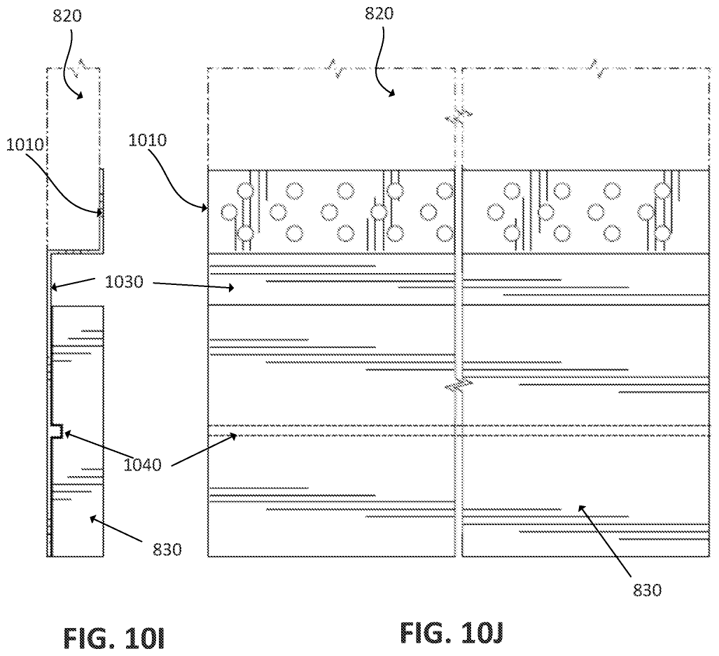

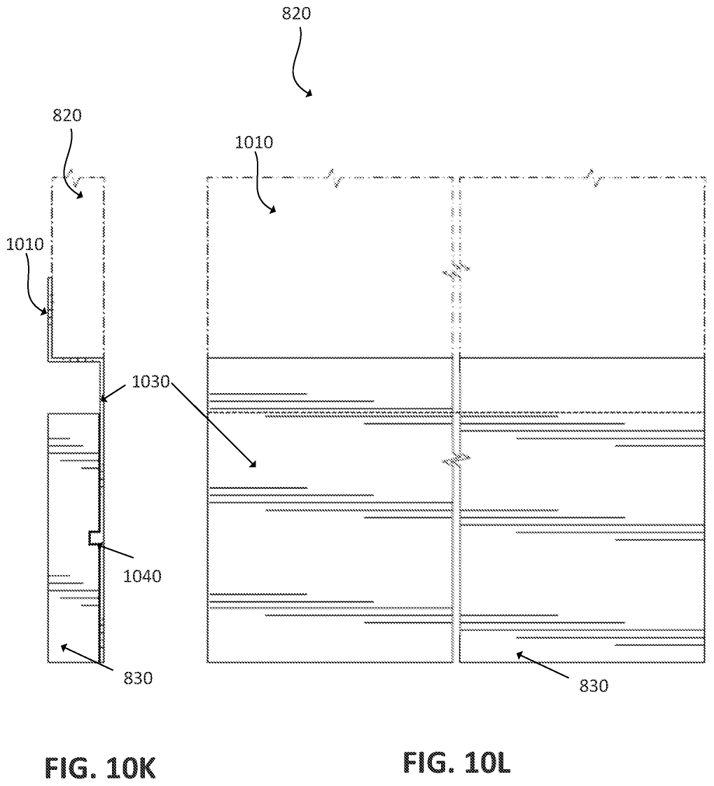

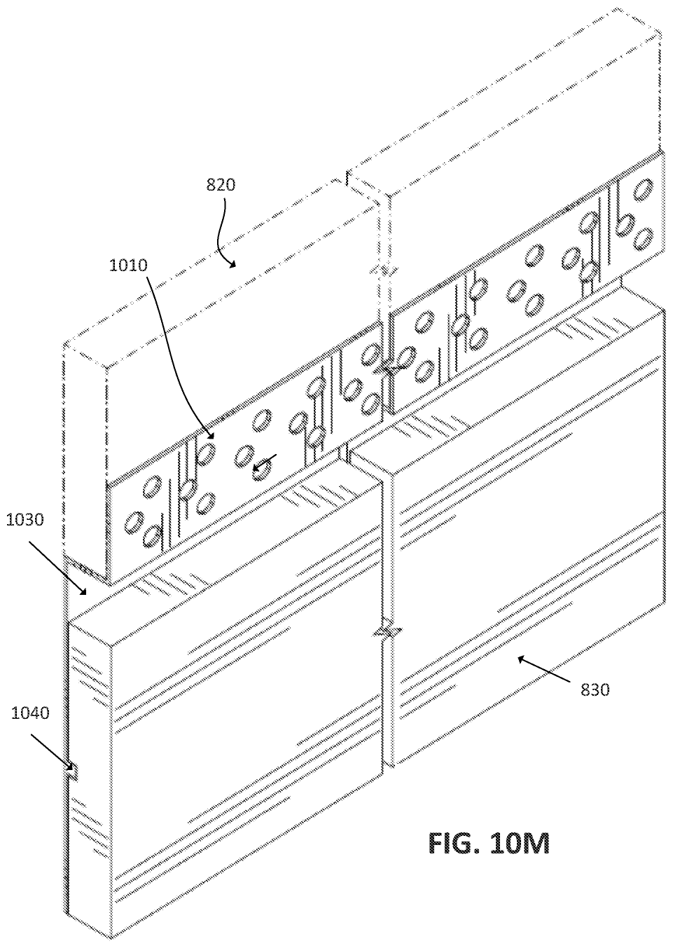

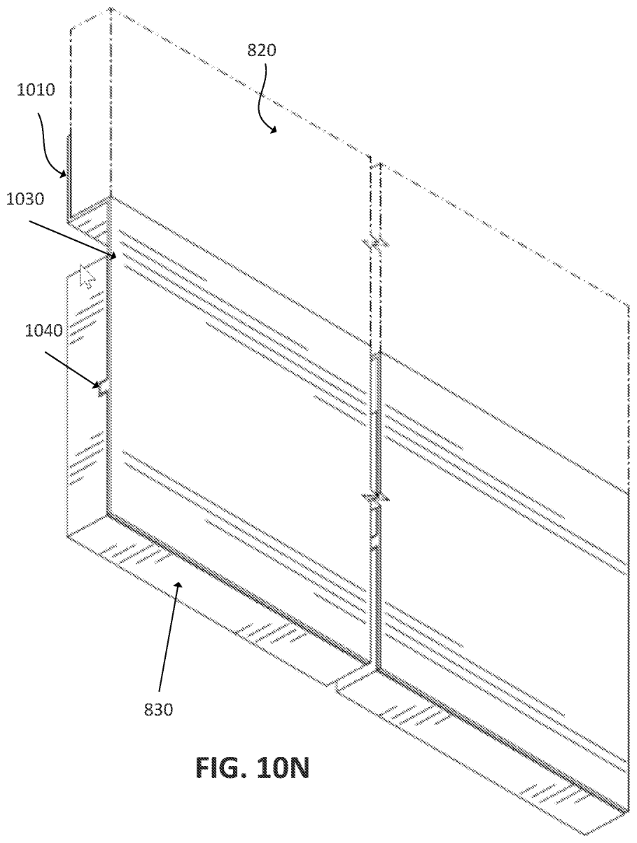

FIGS. 10A-10H show a further variation 1000 of the of the combination reveal and base locator 810 discussed above, wherein a reveal portion 1030 is angled and includes an attachment portion 1010 for attachment to a front surface of the drywall board 820. In an aspect, the combination reveal and base locator 1000 can be made of plastic, metal for compounding, or other suitable material that can be stapled or screwed onto the front surface of the drywall board, for example though holes 1020, and then plastered over to appear flush with the drywall. The reveal portion 1030 extends downwardly from angled attachment portion 1010 and includes a rib 1040 that projects horizontally from the front surface of the reveal portion 1030 and functions as a baseboard locator that is dimensioned to fit into groove 850 in the baseboard 830, shown in FIGS. 11A and 11B. In embodiments, the reveal portion 1030 extends downwardly below rib 1040 for additional stability. However, in other embodiments the reveal portion 1030 extends downwardly only as far as the rib 1040, as in the embodiments of FIGS. 9A-9H.FIGS. 10I-10M show the combination reveal and base locator 1000 in situ, connected to drywall board 820 and baseboard 830.

FIGS. 11A and 11B show an exemplary baseboard 830 for use with the combination reveal and baseboard locator 810 of FIGS. 9A-9H or the combination reveal and baseboard locator 1000 of FIGS. 10A— 10H. The groove 850 can, for example, be made using a saw blade or a router, or can be molded, and and can have small radii corners.

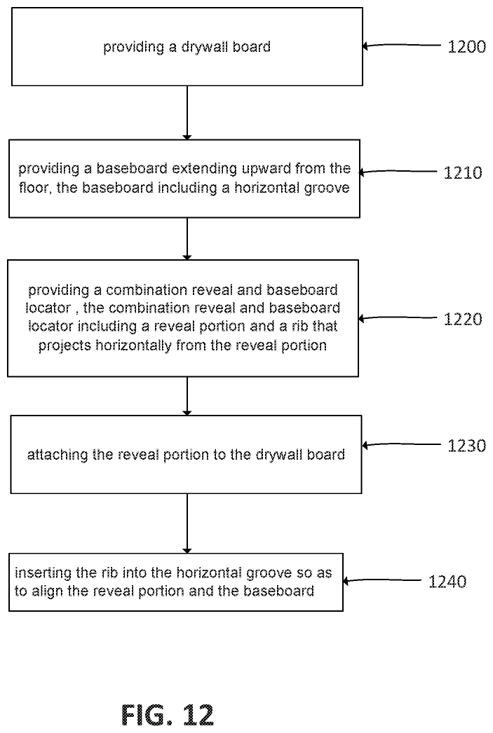

FIG. 12 is a flowchart showing a method for installing drywall to create a reveal in a wall that extends from a floor. At 1200, a drywall board is provided. At 1210, a baseboard extending upward from the floor is provided, wherein the baseboard includes a horizontal groove. At 1220, a combination reveal and baseboard locator is provided, wherein the combination reveal and baseboard locator includes a reveal portion and a rib that projects horizontally from the reveal portion. At 1230, the reveal portion is attached to the drywall board, and 1240 the rib is inserted into the horizontal groove so as to align the reveal portion and the baseboard.

Advantageously, the combination reveal and baseboard locator 810 or 1000 can be attached to baseboard 830 without any need for measurement. The registration provided by inserting rib 840/1040 into groove 850 provides alignment of the reveal with the baseboard.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for installing drywall to create a reveal in a wall that extends from a floor and that is supported by studs, the method comprising:
providing a drywall board having a back side, a front side and a bottom;
securing a backing to the back side of the drywall board so that the backing extends past the bottom of the drywall board;
affixing the drywall board to the studs in an orientation in which the bottom of the board is the bottommost part of the drywall board; and
affixing a baseboard below the drywall board and proximal to the floor such that the baseboard overlaps or abuts the backing, leaving a gap between a top of the baseboard and the bottom of the drywall board to thereby create a reveal that exposes the backing.

2. The method of claim 1, wherein the step of securing includes securing the backing to the back side of the drywall board so that the backing extends past the bottom of the drywall board without contacting the front side of the drywall board.

3. The method of claim 1, such that the drywall board includes gypsum material sandwiched between finishing drywall liner on the front side and framing drywall liner on the back side, wherein the step of securing includes screwing the backing to the back side of the drywall board with screws such that the screws are screwed through the framing drywall liner and into the gypsum material without piercing the finishing drywall liner.

4. The method of claim 1, wherein the step of securing includes fastening the backing to the back side of the drywall board with adhesive.

5. The method of claim 1, wherein the backing has at least one of recessed pockets and projections that mate with complimentary members in the baseboard to facilitate securing the baseboard to the backing.

6. The method of claim 1, wherein the drywall board has a lower lip at the bottom thereof, such that the lower lip is disposed in a folded position, wherein to attain the folded position, a horizontal groove is cut at the back side and the lower lip is rotated to close the horizontal groove.

7. A method for installing drywall to create a reveal in a wall that extends from a floor and that is supported by studs, the method comprising:
providing a baseboard having a back side and a top;
securing a backing to the back side of the baseboard so that the backing extends past the top of the baseboard;
affixing the baseboard to the studs in an orientation in which the top of the baseboard is the topmost part of the baseboard, the baseboard being affixed proximal to the floor; and
affixing above the baseboard a drywall board to the studs such that the drywall board abuts or overlaps the backing, leaving a gap between the top of the baseboard and a bottom of the drywall board to thereby create a reveal that exposes the backing.

8. The method of claim 7, wherein the step of securing includes fastening the backing to the back side of the baseboard with adhesive.

9. The method of claim 7, wherein the backing has at least one of recessed pockets and projections that mate with complimentary members in the drywall board to facilitate securing the drywall board to the backing.

10. The method of claim 7, wherein the drywall board has a lower lip at the bottom thereof, such that the lower lip is disposed in a folded position, wherein to attain the folded position, a horizontal groove is cut at the back side and the lower lip is rotated to close the horizontal groove.

11. The method of claim 7, wherein the baseboard and the backing are formed as one piece.

12. The method of claim 7, wherein the backing includes a horizontal flange on which the drywall board can rest while the drywall board is being affixed to the framing members.

13. The method of claim 1, wherein in the step of affixing a baseboard, the baseboard is affixed to the studs.

14. The method of claim 1, wherein a) in the step of securing, the backing includes one of a metal and a magnet, and b) in the step of affixing the baseboard, the baseboard includes the other of the metal and the magnet, the method further comprising:
in the step of affixing the baseboard, allowing the baseboard to overlap the backing to thereby permit a magnetic force to secure the baseboard to the backing such that a gap remains between a top of the baseboard and the bottom of the drywall board to thereby create a reveal that exposes the backing.

15. The method of claim 14, wherein the backing has at least one of recessed pockets and projections that mate with complimentary members in the baseboard to facilitate securing the backing to the baseboard.

16. A drywall board system for forming a reveal, comprising:
a drywall board for securing to framing members, the drywall board having
a) a back side designed to be adjacent to the framing members when the drywall board is secured thereto, and
b) a front side opposite the back side;
framing drywall liner on the back side;
finishing drywall liner on the front side;
gypsum material sandwiched between the framing and finishing drywall liners;
a backing fastened to the back side of the drywall board, such that the backing extends downward from a bottom of the drywall board without contacting the front side of the drywall board; and
a baseboard secured to and overlapping the backing, such that a gap remains between the top of the baseboard and the bottom of the drywall board, the gap revealing the backing.

17. The drywall board system of claim 16, wherein one of the backing and the baseboard includes a magnet.

18. The drywall board system of claim 16, wherein the board backing has at least one of recessed pockets and projections that mate with complimentary members in the baseboard to facilitate securing the baseboard to the board backing.

19. The drywall board system of claim 16, further comprising a lower lip at the bottom of the drywall board, such that the lower lip is disposed in a folded position, wherein to attain the folded position, a horizontal groove is cut at the back side and the lower lip is rotated to close the horizontal groove.

20. The drywall board system of claim 16, wherein the backing includes a horizontal flange on which the drywall board can rest while the drywall board is being affixed to the framing members.

21. A drywall board system for forming a reveal, comprising:
a drywall board for securing to framing members, the drywall board having
a) a back side designed to be adjacent to the framing members when the drywall board is secured thereto, and
b) a front side opposite the back side;
framing drywall liner on the back side;
finishing drywall liner on the front side;
gypsum material sandwiched between the framing and finishing drywall liners;
a baseboard having a horizontal groove therein; and
a combination reveal and baseboard locator attached to the drywall board, wherein the combination reveal and baseboard locator includes a reveal portion and a rib that projects horizontally from the reveal portion and is dimensioned to fit into the groove in the baseboard and thereby align the reveal portion and the baseboard.

22. The drywall board system of claim 21, wherein the reveal portion of the combination reveal and baseboard locator is straight and attaches to the framing drywall liner on the back side of the drywall board.

23. The drywall board system of claim 21, wherein the reveal portion of the combination reveal and baseboard locator is angled and includes an attachment portion for attachment to the finishing drywall liner on the front side of the drywall board.

24. A method for installing drywall to create a reveal in a wall that extends from a floor, the method comprising:
providing a drywall board;
providing a baseboard extending upward from the floor, wherein the baseboard includes a horizontal groove;
providing a combination reveal and baseboard locator, wherein the combination reveal and baseboard locator includes a reveal portion and a rib that projects horizontally from the reveal portion;
attaching the reveal portion to the drywall board; and
inserting the rib into the horizontal groove so as to align the reveal portion and the baseboard.
